(19) United States
(12) Patent Application Publication
(10) Pub. No.: US 2026/0314586 A1
(43) Pub. Date: Oct. 15, 2026

(54) COMPOSITE MATERIALS AND METHODS FOR INHIBITING OUTDOOR RODENT INGRESS

(71) Applicant: Scapa UK Limited, Manchester (GB)

(72) Inventors: Rebecca Wilson, Stalybridge (GB); Geoffrey Henstock, Greater Manchester (GB)

(21) Appl. No.: 19/645,395

(22) Filed: Apr. 13, 2026

(30) Foreign Application Priority Data
Apr. 15, 2025 (EP) 25170728.7

(51) Int. Cl. A01M 29/30; B32B 5/02; B32B 5/26; B32B 7/06; B32B 7/12

(52) U.S. Cl. CPC A01M 29/30; B32B 5/024; B32B 5/028; B32B 5/26; B32B 7/06; B32B 7/12; B32B 2255/02; B32B 2255/26; B32B 2262/062; B32B 2307/71; B32B 2307/718; B32B 2307/7376; B32B 2405/00

(57) ABSTRACT

Composite materials designed to prevent rodent entry into outdoor structures include a wire mesh layer, a woven layer, an adhesive, and a UV-protective layer made of low-density polyethylene film or crosslinked acrylic polymer coating. The composite material comprises a wire mesh layer, a woven layer, an adhesive, and a UV-protective layer made of low-density polyethylene film or crosslinked acrylic polymer coating. This configuration provides mechanical strength, flexibility, and UV resistance, making the material suitable for outdoor use. The primary application is in forming a tape for sealing gaps and holes in structures to prevent rodent entry. The composite material's robust design ensures long-term effectiveness in harsh environmental conditions, offering a practical pest control solution.

### CROSS-REFERENCE TO RELATED APPLICATIONS

This application claims the benefit of EP Application No. 25170728.7, filed Apr. 15, 2025, the complete disclosure of which is incorporated herein by reference for all purposes.

### TECHNICAL FIELD

This description generally relates to composite materials and methods for sealing holes, gaps, cracks or openings in outdoor structures such as walls, partitions, doors, roofs, and other barriers and more particularly to pest control devices and methods for preventing the ingress of pests, such as rodents, through such barriers.

### BACKGROUND

Controlling rodent ingress into buildings and outdoor structures is a persistent challenge faced by homeowners and businesses alike. Rodents, such as rats, are adept at exploiting gaps, cracks, and holes in barriers, walls, and foundations, which serve as convenient entry points. Once inside, these pests can cause significant damage and pose health risks. Traditional methods of rodent control, such as traps and poisons, often prove ineffective or undesirable due to safety concerns, particularly in environments with children and pets. Moreover, rodents are known for their ability to chew through materials that are not sufficiently durable, further complicating efforts to prevent their entry.

Existing solutions for sealing openings in structures often lack the necessary mechanical strength and durability to withstand environmental stressors and the persistent gnawing of rodents. Many materials degrade over time when exposed to outdoor conditions, reducing their effectiveness as barriers. Additionally, some sealing materials are not designed to be paintable, limiting their application in visible areas, for example, when regulations require the use of certain colors or aesthetics. There is a clear need for a robust, durable, and versatile solution that can effectively seal openings to prevent rodent ingress while maintaining aesthetic appeal and functionality.

### SUMMARY

The description generally related to composite materials that can be formed into a tape which is particularly suitable for use in outdoor applications for preventing the ingress of rodents. The composite material may comprise a wire mesh layer, a woven layer, an adhesive extending through the wire mesh layer, and a UV-protective layer bonded to the woven layer.

In embodiments, the woven layer comprises cotton.

In embodiments, the UV-protective layer comprises a low-density polyethylene film or a crosslinked acrylic polymer coating that provides an aesthetic, robust, and durable barrier solution.

In embodiments, the composite material further comprises a release layer removably coupled to the adhesive on a surface of the adhesive in contact with the first surface of the mesh wire layer.

In embodiments, the wire mesh layer comprises a material selected from the group consisting of stainless steel, aluminum, woven glass and alloys thereof.

In embodiments, the adhesive comprises a hotmelt adhesive.

In embodiments, the thickness of the adhesive is from 0.7 to 2.5 mm or about 1.6 to 2.0 mm.

In embodiments, the thickness of the woven layer is from 0.10 to 0.40 mm or about 0.20 to 0.25 mm.

In embodiments, the UV-protective layer comprises a crosslinked acrylic polymer and the crosslinked acrylic polymer comprises from 0.5 to 4.0 wt%, or about 0.8 to 3.0 wt%, crosslinker relative to the total weight of the crosslinked acrylic polymer.

In embodiments, the UV-protective layer is hydrophobic.

In embodiments, the UV-protective layer comprises a crosslinked acrylic polymer coating, and a surface energy of the crosslinked acrylic polymer coating is at least 24 nM/m (24 dynes/cm).

In embodiments, the UV-protective layer comprises a crosslinked acrylic polymer and a coating weight of the crosslinked acrylic polymer is from 15 to 100 g/m² or about 20 to 50 g/m².

In another aspect, a tape is provided comprising the composite material described herein.

In another aspect, a use of the tape is provided for inhibiting rodent ingress through an opening or a hole in a structure located outdoors. The tape seals the opening or a hole on a surface of the structure located outdoors.

### BRIEF DESCRIPTION OF THE DRAWINGS

FIG. 1 is a schematic of an example composite material;

FIG. 2 is a schematic of an example composite material; and

FIG. 3 is a schematic of an example composite material.

### DESCRIPTION OF EMBODIMENTS

This description and the accompanying drawings describe different embodiments encompassed by the claims for illustration purposes and should not be taken as limiting, with the claims defining the scope of the present invention. Various mechanical, compositional, structural, and operational changes may be made without departing from the scope of this description and the claims. In some instances, structures and techniques well-known in the field have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, the dimensions and values disclosed herein are not to be understood as being strictly limited to the exact numerical values recited. Instead, unless otherwise specified, such value is intended to mean both the recited value and a functionally equivalent range surrounding that value. For instance, whether the word “about” or “approximately” are present or not, the values as presented may be rounded up to the next lower or higher decimal value. For example, 40.15 mm is intended to mean strictly 40.15 mm or “about 40.15 mm”, meaning that the value may vary from 40.10 mm to 40.20 mm. Similarly, 0.122 is intended to mean strictly 0.122 mm or “about 0.122 mm”, which may comprise from 0.120 mm to 0.130 mm. The materials, methods, and examples described herein are illustrative.

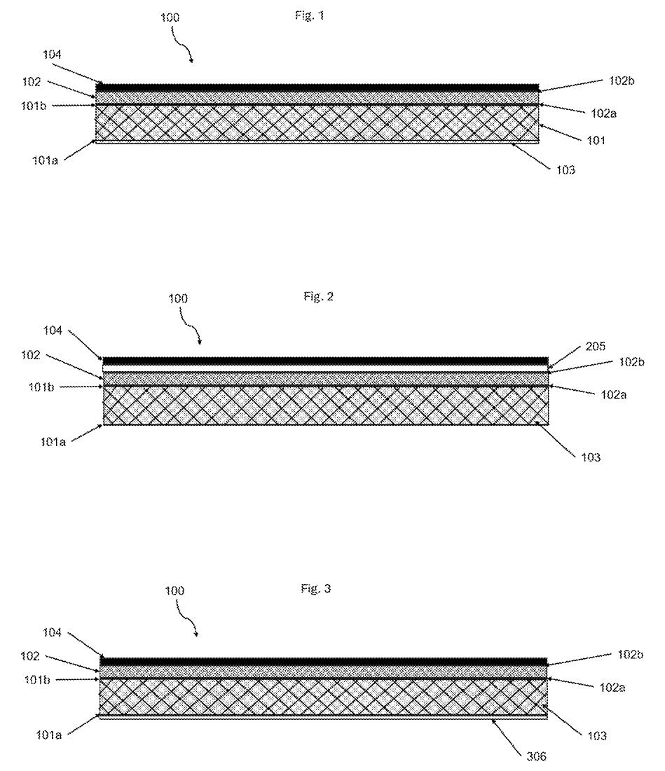

In one embodiment, illustrated by FIG. 1, the composite material 100 comprises a wire mesh layer 101 having a first surface 101a and a second surface 101b opposite the first surface 101a, a woven cotton layer 102 having a first surface 102a and a second surface 102b opposite the first surface 102a, and an adhesive 103 extending through the wire mesh layer 101 from the first surface 101a to the second surface 101b. The first surface 102a of the woven cotton layer 102 is bonded to the second surface 101b of the wire mesh layer 101. The composite material 100 further comprises a UV-protective layer 104 bonded to the second surface 102b of the woven cotton layer 102. The UV-protective layer 104 comprises a low-density polyethylene film or a crosslinked polymer coating.

“Mesh” should be understood to refer to a network or grid-like structure composed of interwoven or interconnected strands. In some embodiments the mesh is made from materials such as metal, plastic, or fiber. Meshes are characterized by their open, lattice-like design, which allows for the passage of air, light, or fluids while providing structural support or reinforcement. In that connection, the open, lattice-like design of the wire mesh 101 allows for the adhesive 103, which is fluid at the moment of application, to extend through from the first surface 101a to the second surface 101b of the wire mesh 101. Wire meshes may be used in applications such as filtration, screening, reinforcement, and as barriers. Mesh generally have a higher degree of flexibility than a bulk material of the same dimensions.

“Woven” should be understood to refer to a method of fabric construction where two sets of yarns or threads are interlaced at right angles to form a textile. This process involves a warp (vertical threads) and a weft (horizontal threads) that are interwoven on a loom to create a stable and durable fabric. Woven materials are characterized by their structured and non-stretchable nature, making them suitable for various applications, including clothing, upholstery, and industrial uses.

“UV-protective” should be understood to refer to a characteristic or property of a material or coating that provides protection against ultraviolet (UV) radiation. This protection can prevent or reduce the degradation, discoloration, or damage that UV radiation can cause to materials, surfaces, or underlying structures. UV-protective layers are often used in outdoor applications to enhance the durability and longevity of products exposed to sunlight.

“Low-density” polyethylene (LDPE) should be understood to refer to a known classification of a polyethylene polymer distinguished by its relatively low density and high degree of branching in its molecular structure. LDPE is distinguishable from other known classifications of polyethylene polymers such as high-density polyethylene (HDPE) being known to be more flexible and less rigid with lower tensile strength and greater transparency.

“Degradation” should be understood to refer to the process by which a material or substance deteriorates or breaks down due to prolonged exposure to environmental factors such as exposure to ultraviolet (UV) radiation, moisture, temperature fluctuations, or chemical reactions. This process can lead to a reduction in the material's structural integrity, functionality, or aesthetic appearance, making it less effective for its intended use. In the context of this disclosure, degradation may include decomposition, delamination, cracking, reduction in adhesion, and yellowing of the composite material. Degradation can affect the durability and longevity of the product, particularly in outdoor applications.

“Prolonged exposure” should be understood to refer to a time period greater than 1 year, preferably greater than 2 years, and more preferably greater than 3 years.

“Outdoor” should be understood to refer to anything situated, occurring, or used outside, in open-air environments. It is often associated with activities, structures, or conditions that take place outside of buildings, exposed to natural elements such as weather, sunlight, and wildlife. In the context of materials or products, outdoor implies suitability for use in external environments, often requiring durability and resistance to environmental stressors.

The composite material 100 configuration provides a robust barrier against rodent ingress by utilizing the mechanical strength of the wire mesh, which is resistant to chewing, thereby preventing rodents from penetrating the material.

The adhesive 103 ensures a secure bond between the wire mesh and the cotton layer, facilitating easy application and long-term adhesion to surfaces. In some embodiments the adhesive extends through from the first surface 101a to the second surface 101b of the wire mesh 101, extending also outside of the first surface 101a, as illustrated by the adhesive shown in FIG. 1. However, the adhesive may also extend only through from the first surface 101a to the second surface 101b of the wire mesh 101 as illustrated by the adhesive shown in FIG. 2.

The UV-protective layer 104, comprising either a low-density polyethylene film or a crosslinked acrylic polymer coating, enhances the material's durability by protecting against degradation due to ultraviolet radiation, making the composite suitable for outdoor use. This combination of layers results in a composite material 100 that effectively seals openings, resists environmental stressors, and maintains functionality over time, offering a practical solution for preventing rodent ingress in outdoor structures.

The woven cotton layer 102 adds structural integrity and flexibility, allowing the composite to conform to various surfaces while maintaining strength. The woven cotton layer 102 also provides UV resistance to the composite material 100. As compared to synthetic woven fabrics such as polytetrafluoroethylene (PTFE), the woven cotton layer has a high surface energy, thereby allowing a wide range of coatings to be disposed thereon. The woven cotton layer 102 also provides a sustainable alternative to the use of synthetic fabrics.

In some embodiments, the woven cotton layer 102 is treated with a proofing agent coating to prevent adhesive 103 from penetrating through the woven cotton layer 102, and prevents thus, the adhesive 103 from contacting the UV-protective layer 104. As illustrated by FIG. 2, the composite material 100 further comprises the proofing agent coating, such as a barrier coating 205 impregnated on the second surface 102b of the woven cotton layer 102. The barrier coating 205 fills pores within the woven cotton layer 102 to form a solid barrier onto which the UV protective coating 104 is disposed. In some examples, the barrier coating 205 may be a starch-based coating such as potato starch, rice flour, tapioca, arrowroot powder, polylsine, or combinations thereof. However, the barrier coating 205 is not limited thereto and may be comprised of any material, such as a polymer film, wax, or silicone, which fills the interstices between the cotton fibers and as a consequence prevents capillary action of the material forming the UV protective layer through the woven cotton, while at the same time, maintaining sufficient surface energy of the woven cotton layer to allow the UV protective coating 104 to be coated thereon rather than be absorbed.

In some embodiments, as illustrated in FIG. 3, the composite material 100 may further comprise a release layer 306 removably coupled to the adhesive 103 on a surface of the adhesive present on the first surface 101a of the wire mesh layer 101, optionally in contact with the first surface 101a. Inclusion of the release layer 306 enhances the usability and application of the composite material 100. This configuration allows for easier handling and application of the composite material 100 by protecting the adhesive 103 until the moment of use. The release layer 306 prevents premature adhesion to unintended surfaces, ensuring that the adhesive 103 maintains its integrity and effectiveness until the composite material 100 is ready to be applied to the target area. This feature is particularly beneficial in outdoor environments where precise placement is important to effectively seal openings and prevent rodent ingress. By facilitating a controlled and clean application process, the release layer 306 contributes to the overall durability and reliability of the composite material 100 in sealing gaps and holes in various structures. The release layer 306 also allows the composite material 100 to be packaged without compromising the integrity of the adhesive. For example, when the release layer 306 is present, the composite material may be formed into a tape which is packaged about a spool, or cut in different sheets which may be stacked together in a package, to provide a compact and easy to use final product.

In some embodiments, the wire mesh layer 101 comprises a metal. The metal wire mesh provides a robust physical barrier that is difficult for rodents to chew through, thereby preventing their entry into structures. This arrangement leverages the mechanical strength and durability of metal, which is superior in resisting gnawing and environmental stressors. The use of metal in the wire mesh layer 101 also contributes to the longevity of the composite material 100, as metals typically exhibit better wear resistance and less degradation over time compared to other materials. This feature is particularly advantageous in outdoor applications where the composite material 100 is exposed to varying weather conditions, ensuring that the barrier remains effective over extended periods. Additionally, the metal wire mesh can be formed into various configurations, such as crimped or calendared structures, to further enhance its structural integrity and adaptability to different surfaces.

In other embodiments, the wire mesh layer 101 may comprise other materials so long as it is resistant to rodent’s chewing to thwart the rodent from chewing through the material. Other materials may include plastics, fibers, multi-filaments and the like, that are processed into a structure of interlocking loops. Suitable metals for the mesh include copper and all alloys, stainless steel and all alloys, steels of all types, carbon steel, coated steel, super alloys, iron, titanium, galvanized steel, tungsten, zinc, woven glass, aluminum and all alloys, nickel or any combination of the above.

In a preferred embodiment, the wire mesh is selected from the group consisting of stainless steel, an alloy of stainless steel, aluminum, woven glass, and combinations thereof. This material selection ensures a rust-resistant wire mesh, which is therefore especially suited for outdoor applications avoiding possible degradation if the mesh becomes exposed, while maintaining sufficient strength while allowing ease of manufacture.

The steel may have a width of from 50 mm to 150 mm, preferably from 75 mm to 125 mm, and a thickness of from 0.1 mm to 1 mm, preferably from 0.4 to 0.6 mm. In an exemplary embodiment, the width of the wire mesh is 95 mm and the thickness is 0.453 mm.

The wire mesh may comprise from 0.5 stiches per cm to 15 stiches per cm, preferably from 5 to 10 stiches per cm, and more preferably 5 stitches per cm, and may be considered fine, medium-fine, standard, coarse or super-coarse. This configuration ensures the wire mesh is sufficiently resistant to chewing and pest ingress. The wire mesh may be formed from crimping, calendaring, folding, layering and rolling processes.

The wire mesh layer 101 may have a pore size of from 1 to 2 mm, from 13 to 17 wales per cm, and from 9 to 13 courses per cm. The wales and courses per cm are measured by visually counting the wales and courses per cm. This spacing allows for the adhesive 103 to penetrate from the first surface 101a to the second surface 101b to bond to the woven cotton layer 102 while also ensuring a knitted weave spacing small enough to prevent rodents from crossing through composite material 100.

In the context of textiles, "wales" refer to the vertical columns of loops in knitted fabrics. They are akin to the warp threads in woven fabrics and are formed by the continuous interlocking of yarn loops. The number of wales per unit length can affect the texture, appearance, and mechanical properties of the fabric, such as its stretchability and durability.

In the context of textiles, a "course" refers to the horizontal row of loops or stitches in a knitted fabric. It is analogous to the weft in woven fabrics and is formed by the continuous interlocking of yarn loops across the width of the fabric. The number of courses per unit length can influence the texture, appearance, and mechanical properties of the fabric, such as its stretchability and durability.

The adhesive 103 may comprise a hot-melt adhesive 103. The adhesive 103 serves to both bond the woven cotton layer 102 to the wire mesh layer 101 and to provide an opposing sticky surface for adhering the composite material 100 to a desired area. In a preferred embodiment, the adhesive 103 comprises a crosslinked acrylic hot-melt polymer comprising a cationic crosslinker. This adhesive 103 composition allows for a strong and durable bond between the wire mesh and the woven cotton layer 102, ensuring that the composite material 100 maintains structural integrity over time. The use of a crosslinked acrylic hot-melt adhesive 103 provides several advantages, such as rapid setting and strong adhesion, which are particularly beneficial in outdoor applications where environmental conditions can be harsh. The hot-melt adhesive’s ability to form a robust bond quickly facilitates efficient manufacturing processes and simplifies the application of the composite material 100 in sealing openings. Additionally, the hot-melt adhesive’s resistance to moisture and temperature variations enhances the durability of the composite material 100, making the composite material 100 suitable for long-term use in preventing rodent ingress. This arrangement effectively addresses the challenge of maintaining a secure seal in environments subject to fluctuating weather conditions.

In other embodiments, the adhesive 103 may comprise a thermoplastic adhesive 103 that may include a base layer comprising ethylene-vinyl acetate (EVA), ethylene-acrylate copolymers, polybutene, amorphous polyolefin, polyamides, polyesters, polyurethanes, styrene block copolymers (SBC), polycaprolactone, polycarbonates, fluoropolymers, silicone rubbers, polypyrrole (PPY) and the like. The referred thermoplastic adhesives are particularly UV resistant and accordingly, they allow obtaining a composite material 100 with excellent properties for outdoor applications.

The thermoplastic adhesive 103 may include one or more additives, such as tackifiers, waxes, plasticizers, antioxidants, UV stabilizers, pigments, dyes, glitter, biocides, flame retardants, antistatic agents, fillers and the like.

The adhesive 103 may have a thickness of from 0.7 to 2.5 mm, preferably from 1.6 to 2.0 mm, and more preferably 1.8 mm. This precise control over the thickness ensures optimal penetration of the adhesive 103 through the wire mesh layer 101, so that an adequate bonding strength between the wire mesh layer 101 and the woven cotton layer 102 is obtained, which is important for maintaining the structural integrity of the composite material 100. The thickness provides a balance between flexibility and durability, allowing the adhesive 103 to effectively penetrate the wire mesh layer 101 while providing a robust bond that can withstand environmental stressors (humidity, oxygen, UV light, etc.). This configuration enhances the ability of the composite material 100 to adhere securely to various surfaces, ensuring long-term effectiveness in sealing openings and preventing rodent ingress. Additionally, the specified thickness range allows for efficient manufacturing processes, as the thickness provides a consistent adhesive application that can be reliably reproduced, reducing variability in product performance. The thickness of the adhesive 103 is measured using a micrometer with 50kPa foot pressure.

The woven cotton layer 102 may have a tensile strength from 40 to 200 N/cm, preferably from 100 to 160 N/cm, and more preferably 125 N/cm. This tensile strength ensures that the woven cotton layer 102 provides sufficient structural integrity and flexibility to the composite material 100, allowing the material to conform to various surfaces while maintaining strength. The specified tensile strength range is important for the ability of the composite material 100 to withstand mechanical stress and environmental conditions, such as wind, humidity and temperature fluctuations, without tearing or degrading. This characteristic enhances the durability and reliability of the composite material 100 in outdoor applications, ensuring effectiveness in sealing openings and preventing rodent ingress over time. By selecting a tensile strength that balances flexibility and robustness, the composite material 100 can adapt to different surface contours and maintain a secure seal, thereby addressing the challenge of providing a long-lasting barrier against pests. The tensile strength of the woven cotton layer 102 is measured according to BS 3924, ASTM D 1000, BSEN 1940 and 1941, BSEN ISO 1421.

A thickness of the woven cotton layer 102 may be from 0.10 to 0.40 mm, preferably from 0.20 to 0.25 mm, more preferably 0.22 mm. This precise control over the thickness of the woven cotton layer 102 ensures that the composite material 100 maintains a balance between flexibility and structural integrity. The specified thickness allows the material to conform to various surfaces while providing sufficient strength to resist tearing or degradation under mechanical stress and environmental conditions. This characteristic is important for the ability of the composite material 100 to effectively seal openings and prevent rodent ingress over time, particularly in outdoor applications where the material is exposed to fluctuating weather conditions. The thickness of the woven cotton layer 102 is measured using a micrometer with 2kPa foot pressure

A thread count of the woven cotton layer 102 may be from 59 by 51 threads per inch to 103 by 93 threads per inch, preferably from 64 to 56 threads per inch. Such thread count ensure a durable and robust woven cotton layer while also maintaining flexibility to conform to a variety of shapes and surfaces. This ensures the composite material 100 will maintain proper adhesion to the desired surface onto which it is adhered.

By optimizing the thickness and thread count of the woven cotton layer 102, the composite material 100 can adapt to different surface contours, ensuring a secure and durable seal while ensuring sufficient tensile strength to address the challenge of providing a long-lasting barrier against pests.

In some embodiments, the UV-protective layer 104 comprises a low-density polyethylene film. The low-density polyethylene may be subjected to a corona treatment on a surface thereof to improve the surface energy of the low-density polyethylene to ensure wettability. The low-density polyethylene may also include a UV-stabilizer.

In some embodiments the UV-protective layer 104 comprises a crosslinked acrylic polymer coating. In some embodiments, the crosslinked acrylic polymer comprises a water-based self-crosslinking acrylic emulsion. The crosslinked acrylic polymer may also comprise added crosslinker, wherein the crosslinked acrylic polymer comprises from 0.5 to 4.0 wt% crosslinker, preferably from 0.8 to 3.0 wt% crosslinker, relative to the total wet weight of the crosslinked acrylic polymer, wherein the total wet weight refers to the total weight of the self-crosslinking acrylic emulsion and crosslinker prior to drying to form the UV-protective layer 104. This crosslinker content ensures a high degree of crosslinking in the resulting UV-protective layer 104. This crosslinker content enhances the durability and mechanical properties of the UV-protective layer 104. By adjusting the crosslinker content within the desired range, the material achieves an optimal balance between flexibility, rigidity, and UV-protection which is important for maintaining the integrity of the protective layer 104 under environmental stressors such as UV radiation, oxygen or humidity. This crosslinking not only improves the resistance to cracking and delamination but also ensures that the protective layer 104 remains intact over prolonged exposure to outdoor conditions. As a result, the composite material 100 is better suited for long-term use in sealing applications, effectively preventing rodent ingress while maintaining its structural and protective properties.

In some embodiments, the UV-protective layer 104 is hydrophobic. This hydrophobic property enhances the UV-protective layer’s 104 resistance to moisture, which is particularly beneficial in outdoor applications where exposure to rain or humidity is common. By repelling water, the coating helps prevent moisture penetration that could otherwise lead to degradation of the underlying layers, such as the woven cotton layer 102, the wire mesh layer 101, or the adhesive 103. This moisture resistance contributes to the longevity and durability of the composite material 100, ensuring that the composite material 100 maintains structural integrity and effectiveness in sealing openings against rodent ingress over extended periods. Additionally, the hydrophobic nature of the UV-protective layer 104 can reduce the likelihood of mold or mildew growth, further preserving the functionality and appearance of the composite material 100. This feature is especially advantageous in environments where maintaining a clean and dry surface is important for both aesthetic and practical reasons.

A surface energy of the crosslinked acrylic polymer coating is at least 24 mN/m (24 dynes/cm), for example at least 30 mN/m (30 dynes/cm), or for example from 35 mN/m to 60 mN/m (35 to 60 dynes/cm), and in a specific example 38 mN/m (38 dynes/cm). This configuration enhances the ability of the composite material 100 to resist environmental degradation, particularly in outdoor applications. The specified surface energy range ensures that the coating provides an optimal balance between hydrophobicity and adhesion, which is important for maintaining the integrity of the UV-protective layer 104 under various weather conditions. By achieving this balance, the composite material 100 can effectively prevent moisture penetration and resist UV-induced damage, thereby prolonging the lifespan of the composite material 100 when used as a barrier against rodent ingress. This characteristic is particularly advantageous in maintaining the structural and functional properties of the composite material 100 over time, ensuring reliable performance in sealing applications. The surface energy of the crosslinked acrylic polymer is measured applying a dyne pen of known wettability for 3 seconds or more. The dyne pen is applied by hand in a controlled environment, for example 23 degrees C and 45% relative humidity. The surface energy is alternatively measured using contact angle equipment, such as a Wilhelmy plate measurer. In some embodiments, a coating weight of the crosslinked acrylic polymer in the UV-protective layer 104 subsequent to crosslinking and drying is from 15 to 100 g/m², preferably from 20 to 50 g/m², more preferably 30 g/m². This precise control over the coating weight ensures that the UV-protective layer 104 provides optimal coverage and protection against ultraviolet radiation, which is important for maintaining the integrity and durability of the composite material 100 in outdoor environments. By selecting a coating weight within the specified range, the crosslinked acrylic polymer achieves a balance between sufficient UV protection and material efficiency, preventing degradation such as cracking or delamination over time. This characteristic enhances the ability of the composite material 100 to withstand prolonged exposure to sunlight, thereby extending its lifespan and effectiveness in sealing openings and preventing rodent ingress. Additionally, the controlled coating weight ensures a uniform and consistent surface finish that can be painted or otherwise treated without compromising the protective properties. The coating weight may be measured by cutting a sample after coating of known surface area and weight and calculating the coating weight based on a known uncoated sample of the same surface area and known weight.

In some embodiments, when a low-density polyethylene film is selected for the UV-protective layer 104, the UV-protective layer 104 further comprises a UV-protective additive. Such additives include UV absorbers such as benzophenones, benzotriazoles, and carbon black; hindered amine light stabilizers; and quenchers such as nickel-based quenchers.

In addition to providing UV-protection to the composite material 100, the UV-protective layer 104 provides a functional outer layer that covers the woven cotton layer 102, providing a surface for handling the tape, and provides a paintable surface for an end user to augment in order to camouflage the composite material 100 into the exterior surface onto which it is adhered.

The composite material 100 may be incorporated or formed into a tape. This tape configuration allows for the practical application of the composite material 100 in sealing openings or holes on surfaces of objects located outdoors. The integration of the composite material 100 into a tape form enhances usability and convenience, enabling easy handling and application. The tape's structure, which includes the wire mesh layer 101, the woven cotton layer 102, the adhesive 103, and the UV-protective layer 104, provides a robust and durable solution for preventing rodent ingress. This combination of features makes the tape particularly suitable for outdoor applications, where the tape can withstand environmental stressors while maintaining the sealing function. Thus, some embodiments refer to a tape for inhibiting rodent ingress through an opening or a hole in a surface of a structure located outdoors, the tape comprising a wire mesh layer 101 having a first surface 101a and a second surface 101b opposite the first surface 101a; a woven cotton layer 102 having a first surface 102a and a second surface 102b opposite the first surface 102a; an adhesive 103 extending through the wire mesh layer 101 from the first surface 101a to the second surface 101b; the first surface 101a of the woven cotton layer 102 bonded to the second surface 101b of the wire mesh layer 101; and a UV-protective layer 104 bonded to the second surface 102b of the woven cotton layer 102, wherein the UV-protective layer 104 comprises a low-density polyethylene film or a crosslinked acrylic polymer coating.

Some embodiments refer to the use of the tape comprising the composite material 100 for sealing an opening or a hole on a surface of a structure located outdoors. Some embodiments, refer to the use of the tape for inhibiting rodent ingress through a structure located outdoors. The tape comprising the composite material 100 provides a robust barrier against rodent entry. The combination of layers in the composite material 100 results in a tape that effectively seals openings, resists environmental stressors, and maintains functionality over time, offering a practical solution for preventing rodent ingress through outdoor structures. The tape may be adhered to any structure, such as a fence, a wall, a roof or a door, adhering to various known materials in modern construction such as wood, metal, plastics such as PVC, brick, stone, and cement.

1. A composite material comprising:
a wire mesh layer having a first surface and a second surface opposite the first surface;
a woven layer having a first surface and a second surface opposite the first surface;
an adhesive extending from the first surface of the wire mesh layer to the second surface of the wire mesh layer;
the first surface of the woven layer in contact with the second surface of the wire mesh layer; and
a UV-protective layer in contact with the second surface of the woven layer.

2. The composite material of claim 1, wherein the UV-protective layer comprises a low-density polyethylene film or a crosslinked acrylic polymer coating.

3. The composite material of claim 1, wherein the woven layer comprises cotton.

4. The composite material of claim 1, further comprising a release layer removably coupled to the adhesive on a surface of the adhesive in contact with the first surface of the mesh wire layer.

5. The composite material of claim 1, wherein the wire mesh layer comprises a material selected from the group consisting of stainless steel, aluminum, woven glass, alloys thereof, and combinations thereof.

6. The composite material of claim 1, wherein the adhesive comprises a hotmelt adhesive.

7. The composite material of claim 1, wherein a thickness of the adhesive is from 0.7 to 2.5 mm.

8. The composite material of claim 7, wherein the thickness is from 1.6 to 2.0 mm.

9. The composite material of claim 1, wherein a thickness of the woven layer is from 0.10 to 0.40 mm.

10. The composite material of claim 9, wherein the thickness of the woven layer is from 0.20 to 0.25 mm.

11. The composite material of claim 1, wherein the UV-protective layer comprises a crosslinked acrylic polymer and the crosslinked acrylic polymer comprises from 0.5 to 4.0 wt% crosslinker relative to the total weight of the crosslinked acrylic polymer.

12. The composite material of claim 11, wherein the crosslinked acrylic polymer comprises from 0.8 to 3.0 wt% crosslinker relative to the total weight of the crosslinked acrylic polymer.

13. The composite material of claim 1 wherein the UV-protective layer is hydrophobic.

14. The composite material of claim 1 wherein the UV-protective layer comprises a crosslinked acrylic polymer coating and a surface energy of the crosslinked acrylic polymer coating is at least 24 nM/m (24 dynes/cm).

15. The composite material of claim 1, wherein the UV-protective layer comprises a crosslinked acrylic polymer and a coating weight of the crosslinked acrylic polymer is from 15 to 100 g/m^{2.}

16. The composite material of claim 15, wherein the coating weight is from 20 to 50 g/m².

17. A tape comprising the composite material of claim 1.

18. A method for inhibiting rodent ingress through an opening or a hole in a structure located outdoors with the tape of claim 1.

19. The method according to claim 18, wherein the tape seals the opening or a hole on a surface of the structure located outdoors.
